(19) United States
(12) Patent Application Publication
(10) Pub. No.: US 2011/0075399 A1
(43) Pub. Date: Mar. 31, 2011

(54) Foldable Water-Proof Light Emitting Clothing

(76) Inventor: Shih-Hwa Yuan, Shulin City (TW)

(21) Appl. No.: 12/568,964

(22) Filed: Sep. 29, 2009

(51) Int. Cl. F21V 21/08

(52) U.S. Cl. 362/103; 362/157

(57) ABSTRACT

A piece of foldable water-proof light emitting clothing includes a light emitting assembly connected with said light emitting, including a foldable wire cable of a plurality of LED's, a cable base of either colored or transparent plastic, and a transparent device mounted over the LED wire cable. A colored or light-reflective cable of a plurality of holes either is mounted over the LED wire cable. A battery pack receiver houses the battery pack.

### FIELD OF INVENTION

This invention relates to a piece of foldable water-proof light emitting clothing; and, in particular, it relates to a light emitting vest-like piece including a light emitting assembly of foldable wire cable including LED's (Light Emitted Diodes).

### DESCRIPTION OF PRIOR ART

The light emitting clothing accessories are designed to protect night-working people from being hurt in dim light condition. The light emitting clothing has to be light, foldable, and easy to clean. Most light emitting clothing of prior arts includes wires which are stiff and not foldable, causing wires to break easily. Therefore, a preferred embodiment of this invention is disclosed to overcome the shortcomings.

### BRIEF SUMMARY OF THE INVENTION

The main purpose of this invention is to improve on the current reflective clothing, and to take advantage of the flexibility of an light emitting assembly for easy of carrying and cleaning.

The foldable water-proof light emitting clothing disclosed in the invention includes a light emitting assembly mounted to a piece of wardrobe. The light emitting assembly is connected with a battery pack for power supply, and includes a plurality of LED's disposed on a foldable wire cable, a cable base of either colored or transparent plastic material, and a transparent device engaged (by ultrasound or high periodic waves) to the cable base to include both the wire cable and cable cover in between.

Preferably, a colored or light-reflective cable cover is mounted over the wire cable, which includes a plurality of LED holes, corresponding to the plurality of LED's of the wire cable.

Preferably, a battery pack receiver is disposed on the light emitting clothing for housing a battery pack within (which is connected with the light emitting assembly as power supply) and for users to operate the battery switch.

### BRIEF DESCRIPTION OF DRAWINGS

FIG. 1: An exploded view of a preferred embodiment of the light emitting assembly in the invention.

FIG. 2: A 3-D view of a preferred embodiment of light emitting assembly and a battery pack.

FIG. 3: A first view of a preferred embodiment of the light emitting assembly in use.

FIG. 4: A second view of a preferred embodiment of the light emitting assembly in use.

FIG. 5: A third view of a preferred embodiment of the light emitting assembly in use.

FIG. 6: A view of a preferred embodiment of the light emitting assembly folded in a specific configuration in use.

FIG. 7: A view of a preferred embodiment of the light emitting assembly displayed over a piece of trousers.

### DETAILED DESCRIPTION OF DRAWINGS

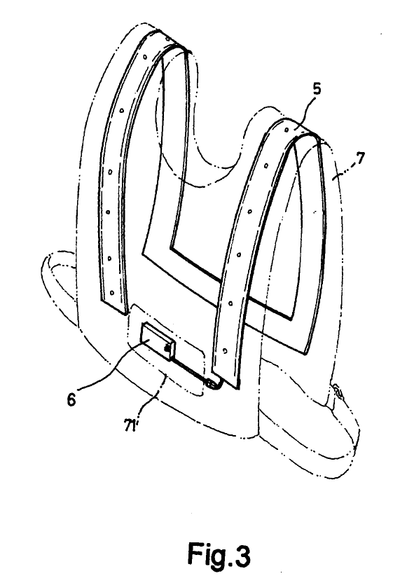

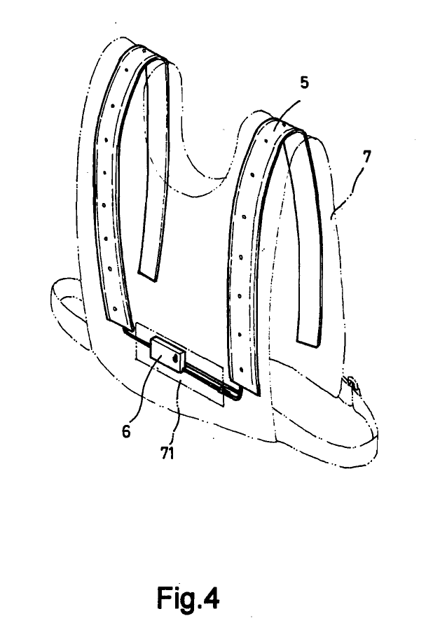

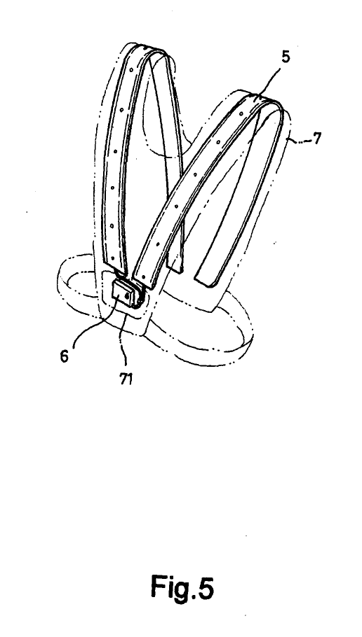

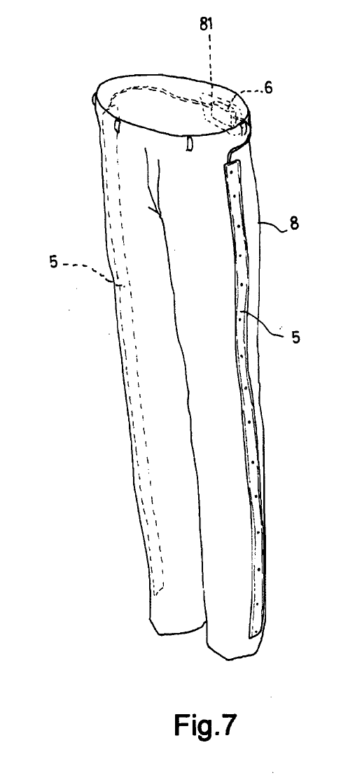

Referring to FIGS. 3 to 5 and 7, the foldable water-proof light emitting clothing disclosed in the invention includes a light emitting assembly 5 mounted to a piece of wardrobe 7 or pants 8. The light emitting assembly 5 is connected with a battery pack for power supply. The foldable water-proof light emitting clothing is put on by users as signaling a warning at night.

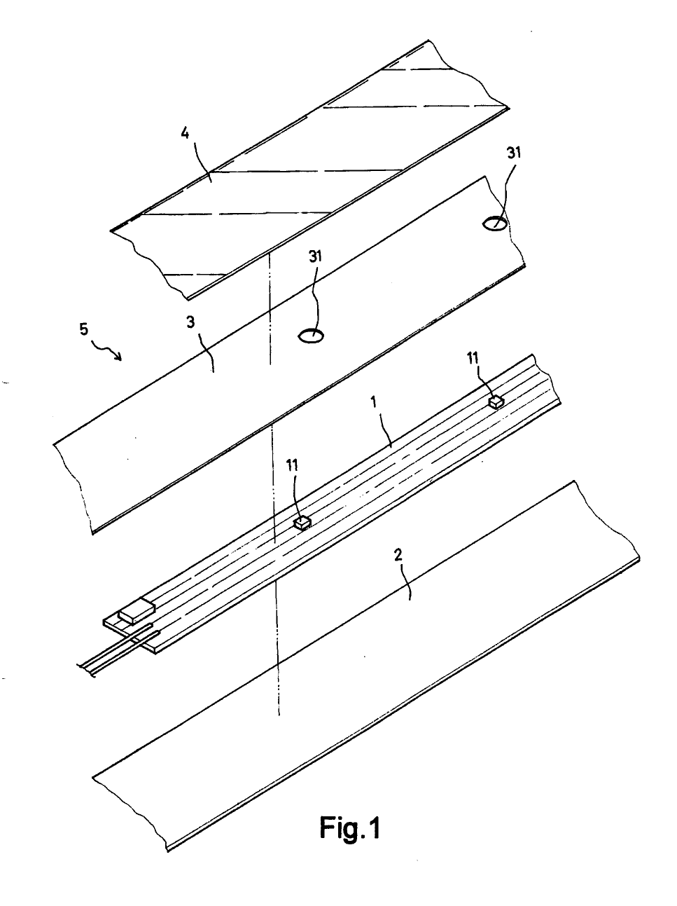

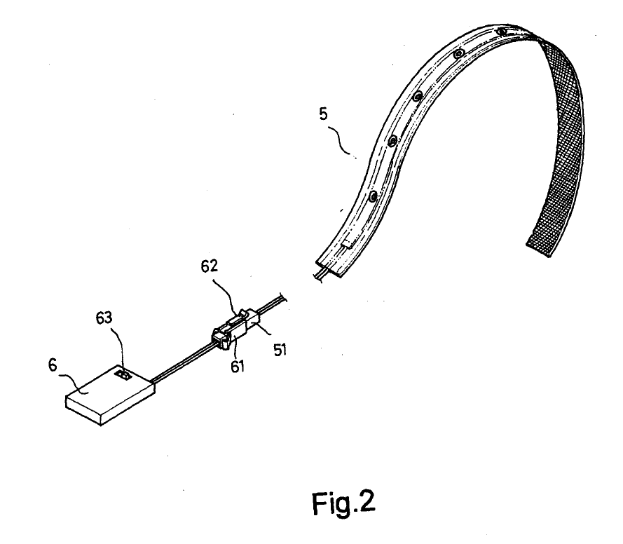

Referring to FIGS. 1 and 2, the foldable water-proof light emitting clothing 5 includes a piece of foldable wire cable 1 including a plurality of LED's, a cable base 2 made of either colored or transparent plastic material (in the preferred embodiment of this invention, the colored cable based is used), a cable cover 3 (which is either colored or light-reflective) mounted over the wire cable 1, and a transparent device 4 mounted over the cable cover 3.

The structural parts of the light emitting assembly 5, from top to bottom, therefore include a transparent device 4, a cable cover 3, a wire cable 1, and, a cable base 2, as shown in FIG. 1. A plurality of LED's 11 are disposed on the wire cable 1, which insert into the holes 31 displayed on the cable cover 3 when the cable cover 3 is mounted over the wire cable 1. In assembling, the wire cable 1 is first assembled with the cable cover 3, and then engaged with the transparent device 4 (on the top) and the cable base 2 (on the bottom, which is either colored or transparent plastic cloth) by ultra-sound or high frequency periodic waves. The final product is a foldable or flexible light-emitting wardrobe, as shown in FIG. 2. The cable connector 51 at one of the light emitting assembly 5 engages with the wire connector 61 in the locking unit 62 of the battery pack 6.

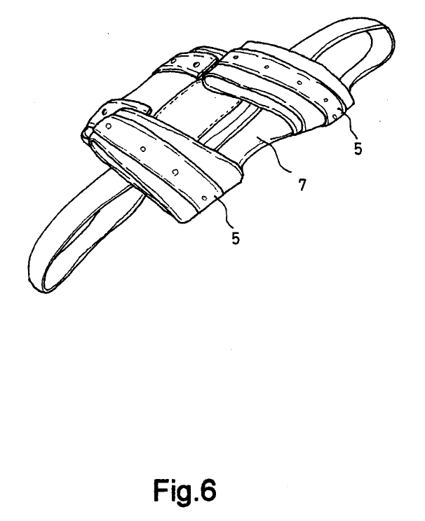

When in use, referring to FIGS. 3 to 5 and 7, the light emitting assembly 5 is displayed over the user's clothes or pants, either in the configuration of U shape as shown in FIG. 3, in the configuration of the shape shown in FIG. 3 with the two ends extending downward, or in the configuration of the V shape shown in FIG. 6.

Furthermore, a battery pack receiver 71 and 81 are disposed on the light emitting clothing for housing the battery pack 6 within (which is connected with the light emitting assembly 5) and also for users to operate on the battery switch 63.

FIG. 6 shows the flexible and foldable nature of the embodiment of this invention. Also, the light emitting clothing can be manually cleaned without effecting the performance of the light emitting assembly 5.

1. A piece of foldable water-proof light emitting clothing, including
a light emitting assembly, and
a battery pack connected with said light emitting assembly for power supply,
wherein said light emitting assembly further includes
p1 a foldable wire cable, including a plurality of LED's,
a cable base, of either colored or transparent plastic, and
a transparent device mounted over said foldable wire cable.

2. The foldable water-proof light emitting clothing as claimed in claim 1, which includes a cable cover of either colored or light-reflective mounted over said wire cable, further including a plurality of holes for LED's on said wire cable to go through.

3. The foldable water-proof light emitting clothing as claimed in claim 1, which includes a battery pack receiver for housing said the battery pack and for users to operate on the switch of said battery pack.
